(19) United States
(12) Patent Application Publication
(10) Pub. No.: US 2004/0227661 A1
(43) Pub. Date: Nov. 18, 2004

(54) Doppler radar system for measuring range, speed, and relative direction of movement of an object

(76) Inventor: Robert C. Godsy, Chanute, KS (US)

Correspondence Address: Tim Cook, Browning Bushman P.C., Suite 1800, 5718 Westheimer, Houston, TX, 77057, US

(21) Appl. No.: 10/435,994

(22) Filed: May 12, 2003

(51) Int. Cl. G01S 13/58

(52) U.S. Cl. 342/70; 342/109; 342/114; 342/115; 342/135; 342/145; 342/189; 342/194; 342/195

(57) ABSTRACT

A ranging Doppler radar system for identifying, and measuring range, velocity, direction of movement of a vehicle with minimal interference from surrounding environs and with low probability of intercept by the vehicle. The transmitted radar signal is modulated with pseudorandom code which acts as a frequency spreading agent and which allows a radar system to resolve range to targets into discrete “range cells”. Range cells can be grouped to yield a “range segment” which defines a region of roadway, such as a school zone. Traffic can be monitored in all range cells, or only in a predetermined range segment. Maps of traffic flow and vehicle parameters are generated and displayed using radar output parameters. Images representing vehicles violating posted speed limits are identified and highlighted on the traffic flow maps. Output from the radar system can be combined with supplemental data such as video and audio communication to yield an even more extensive presentation of traffic flow.

### FIELD OF THE INVENTION

This invention relates generally to the field of Doppler radar systems, and more particularly to a ranging Doppler radar system for identifying and measuring range, velocity, and direction of movement of a vehicle with minimal interference from surrounding environs and with low probability of intercept by the vehicle.

### BACKGROUND OF THE INVENTION

Radar systems have been used for several decades to monitor velocity or “speed” of vehicular traffic, and to identify and document vehicles that are exceeding posted speed limits. Analog display radar units were initially used to measure vehicular speed. In 1970, the first digital traffic radar system was introduced. This system was more reliable and more accurate than its analog predecessors.

In 1972, the first moving radar system was introduced. These systems are mounted within a law enforcement officer's patrol vehicle, and allow the officer to measure speed of approaching vehicles while the officer's vehicle is also moving.

Early traffic radar systems employed analog filtering, which allowed the monitoring unit to detect or “see” only one vehicle that produced the strongest reflected signal. In the early 1990's, Digital Signal Processing (DSP) appeared in traffic radar systems. For the first time, this allowed designers to catalog each of a plurality of incoming detected vehicle speeds, and to make a decision as to which measured speed to display. As with earlier analog units, only vehicles producing the strongest reflected signals are detected and other signals, produced by vehicles with lesser radar cross-sections (RCS), are not seen.

The use of DSP allows new features to be employed in traffic radar systems. One such feature is a “fastest” mode of operation. In addition to vehicular speed generated by the strongest reflected signal, a signal generated by the fastest monitored vehicle can also be displayed in a second display window. The importance of this feature is best illustrated by example. Assume that a large semi-truck is approaching an officer using radar, and that a smaller vehicle, such as a car, is passing the truck. The truck has the larger RCS thus generating a larger reflected signal. By design, the radar displays the speed of the truck obtained from the stronger signal reflected from the truck. With earlier radar units, the radar would never see the faster moving car. By using a radar unit with a “fastest mode” feature, the officer will not only see the speed of the truck in a main display window of the radar unit, but will also see the speed of the car in a second “fastest” display window.

Another feature available in DSP and earlier radar systems is a “mobile” mode. This feature allows a mobile patrol officer to measure the speed of a vehicle traveling in the same direction as the officer's patrol vehicle. There are, however, issues of target identification when multiple vehicles are within radar response range.

Other advances in radar design and DSP radar features allow speed measurements of vehicles either approaching a fixed radar unit operating in a “stationary” mode, or receding from the unit operating in the stationary mode, at the discretion of the radar device operator. This directional radar feature enhances the user's ability to identify speeding vehicles by selectively eliminating either approaching or receding targets from the display. In addition, directional radar sensing is applicable to same lane moving mode operations where discrimination of faster and slower same lane vehicles augments the correct speed presentation.

Many types of radar, including DSP systems, operate at frequencies with relatively narrow bandwidths. Such systems are relatively easy to intercept with radar detection or “radar warning” units which are legal and commercially available to the general public in many areas. The use of radar warning units by speeding vehicles allows the vehicle to temporarily decrease speed while being monitored, and subsequently resume an illegal speed once outside the range of the monitoring radar system. This, of course, hampers law enforcement in effectively detecting and citing habitual “speeders”. Furthermore, many types of radar systems are adversely affected by a number of environmental factors. As an example, a fan operating in an officer's vehicle can result in false readings from a radar unit mounted within the vehicle.

### SUMMARY OF THE INVENTION

This disclosure is directed toward a ranging Doppler radar system for identifying a vehicle, and for measuring range, velocity, and direction of movement of the vehicle with minimal interference from surrounding environs and with low probability of intercept by the vehicle.

The system allows an operator to obtain speed of a target vehicle and correctly identify the vehicle by (1) obtaining a measure of distance or “range” to the target vehicle, and/or (2) by allowing the speed of the intended target vehicle to be displayed only at a predetermined range or range interval. Using the second approach, the operator sets a range or a range interval, and no speed-readings are displayed until the vehicle reaches the predetermined range or is traveling within the predetermined range interval. Speed-readings displayed at these predetermined ranges or range intervals aid the operator to properly correlate an observed vehicle with a corresponding measured speed.

The ranging Doppler radar system is designed to spread the operating frequency using direct sequence (DS) spread spectrum. This feature divides transmitted power over a sin (x)/x frequency range with a bandwidth of twice the code clock frequency thereby reducing interception by commercially available radar detectors that warn drivers of traffic radar operating in an area. Design of the system is such that erroneous readings resulting from surrounding environmental effects are also minimized.

Digital Signal Processing (DSP) is preferably used in the radar system. The system can also be interfaced with one or more video systems, audio communication systems and navigation systems such as the Global Positioning System (GPS) to further aid in providing better traffic enforcement while minimizing erroneous citations.

Basic operating principles of the radar system are summarized as follows. Narrow band transmit energy is generated by applying a transmit enable signal to a narrow band frequency source, which is preferably periodic. Some of this source signal energy is redirected to provide a Local Oscillator (LO) input to a direct-conversion receiver mixer. In addition, this source signal is used as a carrier and is bi-phase modulated in accordance with the input of a primitive polynomial pseudorandom code. The modulated carrier is then directed into a microwave cavity where it is converted from TE₁₀ mode to left-hand circular by the turnstile junction structure thereby forming a transmitted signal. In addition, the turnstile junction can be adjusted to create a high level of isolation between the transmit port and receiver port. Circularly polarized microwave energy is directed through a horn and lens where it creates a cone-shaped antenna pattern that can illuminate target vehicles and collect the return energy. Energy reflected by a target vehicle and detected by the system, commonly referred to as “return energy” signal, is converted back to TE₁₀ mode by the turnstile junction structure. The return energy is then routed through the receiver port and input into the direct-conversion receiver mixer, which provides two channel I/Q output at base band. Output comprises target information.

Return signal energy from a target is dependent upon the target's RCS, signal propagation loss, antenna gain, and the like. The amplitude of the return signal is, therefore, smaller than the amplitude of the corresponding transmitted signal. In addition to the modification of amplitude, target vehicles that are moving relative to the radar system provide a Doppler shift component in the return signal.

The pseudorandom code acts as a frequency spreading agent and allows the radar receiver to resolve range to targets into discrete “range cells”. This, in turn, allows the radar system to separate target vehicles by range. The pseudorandom code is, therefore, a key element in providing the system feature of range resolution. Furthermore, frequency spreading leads to reduced detectable emissions, low probability of intercept, and improved Radio Frequency Interference (RFI) immunity.

The signal detection and correlation portion of the radar system can be accomplished by multiple methods. This disclosure presents two detection and correlation methods. It should be understood, however, that the invention is not limited to these methods and other correlation approaches can be used. One disclosed method is an analog solution, and the second disclosed method is considered a digital solution. Digital solutions are changing, and it is theoretically possible to place an analog to digital converter (ADC) at the receiver input of the radar system. The organization of heterodyning, phase detection, filtering, amplification, and correlation can be varied with the overall operational functional outcome remaining fixed. This disclosure illustrates basic principles of using code detection to obtain range resolution.

The pseudorandom code is selected for length (number of bits N), speed of output (bits per second), and ability to reject adjacent range cell codes. The number of bits, N, determines the amount of gain applied to target returns from the selected range cell. Theoretically, a 64-bit code would give a times-64 gain to correlation output returns from the selected range. A new N bit pseudorandom code is generated each time a new bit is shifted out using the bi-phase modulator. The primitive polynomial used to generate this pattern is selected to give the most even spreading of the carrier frequency, with minimal sidelobe energy and with maximum rejection of adjacent range cell codes. The rate at which the code is shifted determines the spreading bandwidth of the carrier frequency and the range resolution.

The radar receiver aligns the correlation detector to a time at which a specific code return will appear from a given range. Basically, the radar examines each range cell. By scanning through different range cells, targets can be searched for, found, and tracked. Signal to noise improvements can be made by dwelling at a specific range cell and integrating the results. The receiver can also dither around the target range cell and examine other range cells such as adjacent range cells to determine when a target moves into a new range cell.

The radar system scans each range cell searching for a target. Once a target is detected, the radar dwells on the range cell in which the target resides. Dwelling allows integration of signals, separation of different speed targets, and extraction of Doppler speed. After data has been gathered on one range cell, searching continues and targets in other range cells can be analyzed. A target can be tracked, as a function of time, as it passes from one range cell to an adjacent range cell. Vehicular speed and direction of travel can therefore be determined by range cell tracking of a target vehicle as a function of time as it moves through range cells.

A microprocessor-based system uses speed, range, and directional target range data to generate graphical maps of one or more vehicular targets relative to the officer's radar system location. The maps are presented in real-time and display vehicle speed, vehicle range, direction of travel, and other pertinent data. In addition to forming real-time displays, the information can be stored digitally and later replayed. In addition, this recorded data can be time-synchronized with supplemental video and audio data, and replayed for on site evaluation or as evidence during court appearances.

The user of the ranging radar system can define a region or “range segment” in which to monitor speed. A range segment is typically defined by summing two or more adjacent range cells, and can represent a school zone, an intersection, a plant entrance and the like in which posted speed limit differs from adjacent speed limits. This feature allows monitoring of a range segment by setting up a start range and end range. Typically, the speed and range position of all vehicles moving within the range segment are displayed on the real-time display. Graphical images of vehicles exceeding the posted speed limit within the range interval are visually identified by color, by intermittent flashing, or by any other suitable means to draw attention to the monitoring officer. These image enhancements support the radar operator in their ability to properly identify the offending vehicle.

The radar system operating in the “range segment” mode can be used for regular stationary traffic monitoring, and allows the monitoring officer to concentrate on vehicles within a certain region of the road instead of dealing with every target on the road which is within radar range. Since the radar maximum range is typically one mile or more, the ability to monitor a window defined by a predetermined range segment can improve the monitoring officer's ability to deal with heavy traffic, and to insure that a violator is accurately identified, stopped and cited.

### BRIEF DESCRIPTION OF THE DRAWINGS

So that the manner in which the above recited features, advantages and objects of the present invention are obtained and can be understood in detail, more particular description of the invention, briefly summarized above, may be had by reference to the embodiments thereof which are illustrated in the appended drawings.

FIG. 1 illustrates the basic components and associated functions of the ranging Doppler radar system;

FIG. 2 illustrates a digital version of the correlation solution of the ranging radar system;

FIG. 3 shows a conceptual view of radiated radar emissions from a ranging radar system and also illustrates range cells and range elements;

FIG. 4 is an example of a graphical map of traffic flow generated using data measured by the ranging radar system;

FIG. 5 is a functional diagram showing the combination of radar data with other supplemental data; and.

FIG. 6 is an example of a graphical map of traffic flow within a range segment, such as a school zone, generated using data measured by the ranging radar system.

### DETAILED DESCRIPTION OF THE PREFERRED EMBODIMENTS

In disclosing the ranging Doppler radar system, basic principles of operation will first be presented. Once the basic principles of the systems and features of the systems have been discussed, applications of the system will be presented.

Basic Principles

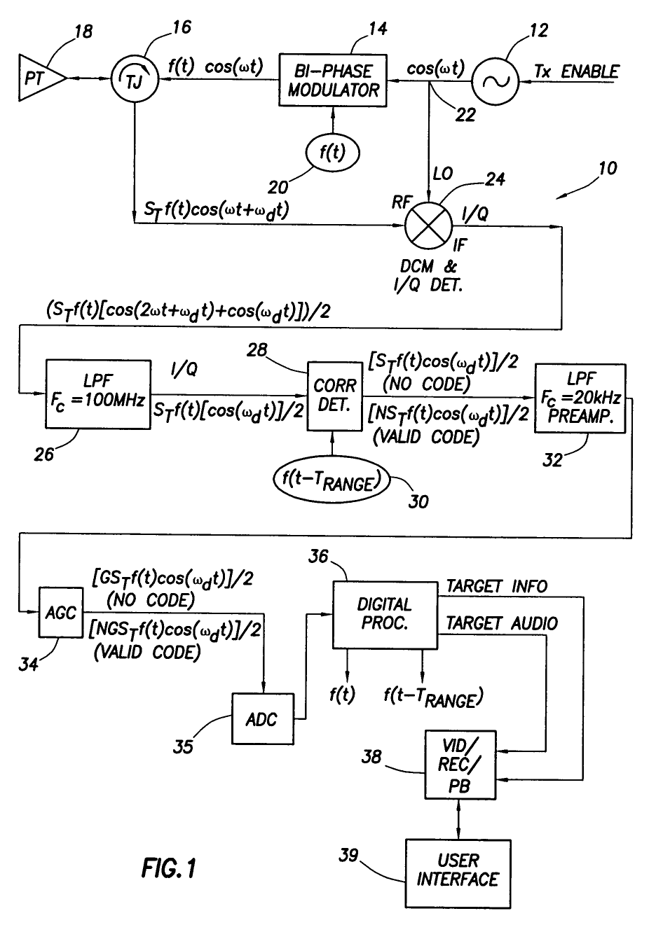

FIG. 1 illustrates the basic components and associated functions of the ranging Doppler radar system 10. Narrow band transmit energy is generated at an oscillator source 12 by applying a transmit enable signal to generate a periodic, narrow band frequency source preferably of the form (cos(ωt)). Some of this source energy is redirected at a junction 22 to provide a Local Oscillator (LO) input to a Direct Conversion receiver Mixer (DCM) 24. The remainder of the source energy, Eₜᵣₐₙₛ, is used as a carrier signal, where

Eₜᵣₐₙₛ=cos(ωt) (1)

where

ω=2π carrier frequency; and

t=time.

Eₜᵣₐₙₛ is preferably within the frequency range Ka-band (27 GHz) (IEEE standard frequency band) and above, or within other approved radio frequency ranges. Eₜᵣₐₙₛ is directed to a bi-phase modulator 14, and is bi-phase modulated in accordance with the input of a primitive polynomial pseudorandom code denoted as f(t) and shown at 20, yielding an output

Eₜᵣₐₙₛ=f(t)cos(ωt) (2)

where

f(t)=a primitive polynomial pseudorandom code which is a function of time t.

The modulated carrier is directed into a microwave cavity 16 where it is converted from TE₁₀ mode to left-hand circular by the turnstile junction structure 16, thereby forming a transmitted signal. In addition, the turnstile junction 16 can be adjusted to create a high level of isolation between the transmit port and receiver port (not shown). Circularly polarized microwave energy is directed through a horn and lens 18 where it creates a cone-shaped antenna pattern that can illuminate targets and collect the return energy signals.

Still referring to FIG. 1, a portion of the transmitted energy is reflected off of a target, such as a vehicle, and returned to the radar system 10 as a return energy signal or simply a “return” signal. The return energy signal Eᵣₑₜᵤᵣₙ is converted back to TE₁₀ mode by the turnstile junction structure 16, where

Eᵣₑₜᵤᵣₙ=S_{T}f(t)cos(ωt+ω_{d}t) (3)

where

S_{T}=amplitude of the return signal; and

ω_{d}=2π×Doppler frequency.

Eᵣₑₜᵤᵣₙ is then routed through the receiver port and input to a direct conversion mixer (DCM 24), which provides two channel I/Q output at base band. Return energy signal Eᵣₑₜᵤᵣₙ is dependent upon the target's RCS, signal propagation loss, antenna gain, and the like. The amplitude ST of the returned signal is, therefore, smaller than the amplitude of the transmitted signal. In addition to the modification of amplitude, targets that are moving relative to the radar system 10 provide a Doppler shift in the return signal, as indicated by the term ω_{d}t in equation (3).

Again referring to FIG. 1, the pseudorandom code f(t) encoded by the bi-phase modulator 14 is selected for length (number of bits N), speed of output (bits per second), and ability to reject adjacent range cell codes. The number of bits, N, determines the amount of gain applied to target return from the selected range cell. Theoretically, a 64 bit code would give a times-64 gain to correlation output returns from the selected range. A new N bit pseudorandom code is generated each time a new bit is shifted out using the bi-phase modulator 14. The primitive polynomial used to generate this pattern is selected to give the most even spreading of the carrier frequency, with minimal sidelobe energy and with maximum rejection of adjacent range cell codes. The rate at which the code is shifted determines the spreading bandwidth of the carrier frequency and the range resolution. The pseudorandom code f(t) acts as a frequency spreading agent and allows the radar receiver to resolve range to targets into discrete range cells. This in turn allows the system to separate targets by range. The pseudorandom code is, therefore, a key element in providing the system feature of range resolution, as will be discussed in detail in subsequent sections of this disclosure.

The signal detection and correlation portion of the radar system 10 can be accomplished by multiple methodologies. This disclosure presents two detection and correlation approaches. It should be understood, however, that other correlation approaches can be used with similar results. One disclosed method is an analog solution, and the second disclosed method is considered a digital solution. Digital solutions are changing, and it is theoretically possible to place an Analog to Digital Converter (ADC) at the receiver input of the radar system. The organization of heterodyning, phase detection, filtering, amplification, and correlation can be varied with the overall operational functional outcome remaining fixed.

FIG. 1 illustrates an analog correlation apparatus and method. The two channel I/Q output from the DCM 24 is of the form

S_{T}/2f(t)[cos(2ωt+ω_{d}t)+cos(ω_{d}t)] (4)

and is input into a Low Pass Filter (LPF) 26 with a cutoff frequency set to about 100 MHz. Output from the LPF 26 is of the form

S_{T}/2f(t)[cos(ω_{d}t)] (5)

and is input into a correlation detector 28 for correlation with f(t−T_{range}), where T_{range} is associated with discrete range cells. Stated another way, the correlation detector 28 looks for various codes f(t−T_{range}) to be sensed from all predetermined range cells to determine if a target is within a given range cell. Correlation output from the correlation detector is

[S_{T}f(t)cos(ω_{d}t)]/2 (6a)

if no code is found, and

[NS_{T}f(t)cos(ω_{d}t)]/2

if a valid code is found. Note that if a valid code is found, the amplitude of the output signal is increased by N, where N is the number of bits. Output from the correlation detector 28 is passed through a low pass filter/preamplifier 32 with a cutoff frequency of about 20 kHz, and then through an Automatic Gain Control (AGC) circuit 32. Output of the AGC 32 is of the form

[GS_{T}f(t)cos(ω_{d}t)]/2 (7a)

if no code is found, and

[NGS_{T}f(t)cos(ω_{d}t)]/2 (7b)

if a valid code is found, where

G=the gain of AGC circuit.

These outputs are then passed through an ADC 35 and into a DSP 36 which generates target specific signals including target range, target speed information, target direction of motion information and supplemental target information that is compatible for input into a video display/recording and playback unit 38. As the name implies, the video display/recording and playback unit 38 is used to display, to record, and to play back the “vehicle specific signals” of the ranging radar system. These vehicle specific signals include vehicle speed, vehicle range, vehicle direction of travel, and various additional parameters. Vehicle specific signals and various features of the system 10 will be discussed in detail in subsequent sections of this disclosure. The video display portion of the video display/recording and playback unit 38 can be a flat screen display, a cathode ray tube display, a LED display, or any other suitable display means visible to the user.

A user interface 39 is operationally connected to the video display/recording and playback unit 38 to allow the user to input pertinent information and to generally control operation of the system 10.

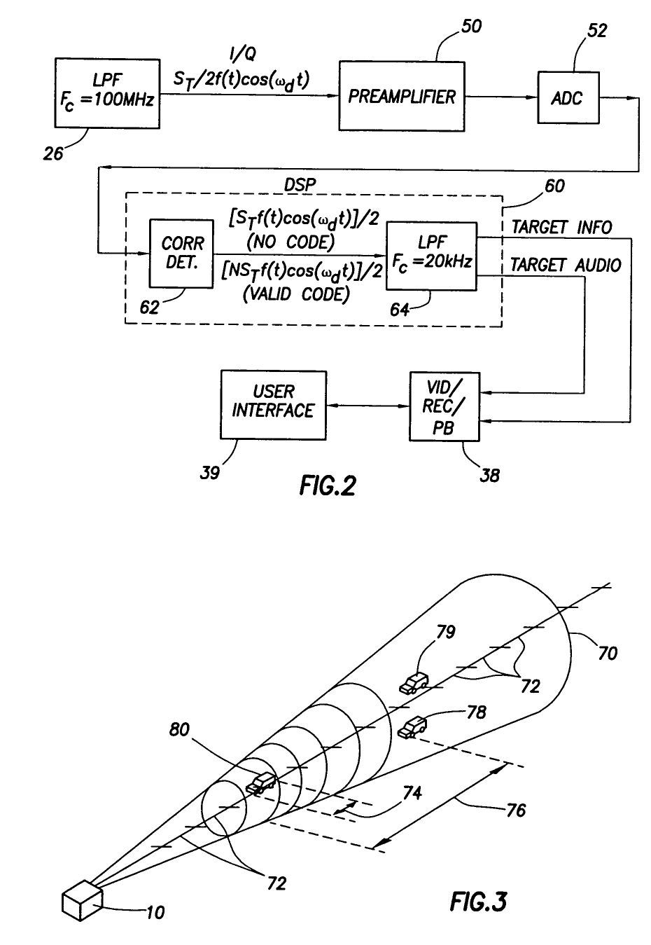

A digital version of the correlation solution of the ranging radar 10 is illustrated as apparatus and method in FIG. 2. Referring to both FIGS. 1 and 2, elements and functions of the radar system 10 are identical through the LPF 26. Now referring to FIG. 2 only, the I/Q output from the LPF 26 is passed through a preamplifier 50 and an ADC 52. The output of the ADC 52 is input into a digital signal processor indicated as a whole by the numeral 60. The digital signal processor 60 comprises a correlation detector 62 and a LPF 64 with a cutoff frequency f_{c} of about 20 kHz. As in previously discussed analog processing, the digital signal is correlated within the correlation detector, which outputs a signal of the form [S_{T}f(t)cos(ωdₜ)]/2 if no code is found, or [NS_{T}f(t)cos(ωdₜ)]/2 if a valid code is found. These signals pass through the LPF 64 which outputs target information and audio information into a previously described video display/recording and playback unit 38 to display the vehicle specific signals of the ranging radar system 10. Again, the user interface 39 is operationally connected to the video display/recording and playback unit 38 for control of the system 10.

FIG. 3 shows a simplified view of radiated radar emissions from a ranging radar system 10, and indicates how a region of space is enhanced by the pseudorandom codes. Emission is in the form of a cone-shaped beam pattern 70, where sidelobes are not illustrated for purposes of clarity. Multiple range cells, R_{c,i}, are illustrated conceptually as indicated by the numeral 72. The range cells are preferably adjacent and are of equal distance. A range segment R_{s,m} is illustrated conceptually at 76 as a sum of adjacent range cells R_{r,i}, and is expressed mathematically as

$${R}_{s , m} = {\sum }_{i = j}^{k} {R}_{c , i} \qquad ( 8 )$$

Still referring to FIG. 3, three vehicles 78, 79 and 80 are shown approaching a ranging radar system 10 within the cone shaped beam pattern 70. Vehicles 78 and 79 are outside of the range segment 76, while vehicle 80 is within a range cell 74 which is included in the range segment 76. If the ranging radar is set to monitor vehicles only within the range segment 76, only the position and speed of vehicle 80 will appear on the video display/recording and playback unit 38 (see FIG. 1). Stated another way, the unit 10 can be set so that reflected signals from vehicles 78 and 79 will not be enhanced by the pseudorandom code. This feature will be illustrated in detail in subsequent sections of this disclosure,

A 50 MHz code bit rate represents a range cell 72 with approximate 10 foot range resolution. Ambiguous range cells occur at the point in space where the code repeats. A 64 bit code that uses every possible bit pattern repeats after 2⁶⁴ patterns have been shifted. Since each of these bit patterns is separated by 10 feet, the first ambiguous range cell 72 is beyond the typical range of the radar system 10. Low power law enforcement radar systems have normal ranges typically 3 miles or less, which implies that even subset code patterns of reasonable size have little concern for ambiguous ranges. It should be understood, however, that other bit code rates could be used depending upon range cell resolution requirements and the range and operating frequency of the radar system.

Returning to FIGS. 1 and 2, the radar system 10 aligns the correlation detector 28 or 62 to a time at which a specific code return will appear from a given range cell. The radar system 10 examines each range cell R_{c,i} denoted by the numeral 72. By scanning through different range cells 72, targets can be searched for, found, and tracked. Once a target is found in a given range cell, signal to noise improvements can be made by dwelling on that range cell, and integrating the results of multiple measurements made during the dwell. This tends to “average out” random noise while preserving the signal, which is present at the same range position in each measurement. Dwelling also allows separation of different speed targets and extraction of Doppler speed. After data has been gathered on one range cell, searching continues and targets at other ranges can be analyzed. The system 10 can also dither around the target range cell (e.g. R_{c,i}) and examine adjacent range cells (e.g. R_{c,i-1} and R_{c,i+1}) to determine when a target moves into a new range cell. Dithering allows a target to be tracked, as a function of time, as it passes from one range cell to an adjacent range cell thereby yielding a second measure of speed of the target vehicle, which is independent of the extracted Doppler speed.

Direction of travel of a target vehicle can also be determined by range cell tracking of a target to determine if it moves from range cell R_{c,i} to preferably adjacent range cell R_{c,i-1} or to preferably adjacent range cell R_{c,i+1}. Stated simply, if range cell R_{c,i-1} is closer to the radar system 10 than R_{c,i} and it is determined that the target moves from range cell R_{c,i} to R_{c,i-1}, then the target is approaching the radar system 10. Conversely, if it is determined that the target moves from range cell R_{c,i} to R_{c,i+1}, then the target is moving away from the radar system 10.

Direction of travel can alternately be calculated by side-band analysis. Direction of travel can be extracted instantaneously using the I/Q mixer 24 (see FIG. 1).

Two targets occupying the same range cell cannot be identified by range. For example, if two vehicles are 5 feet apart in radar radial range and the range cell resolution is 10 feet, then both vehicles would be enhanced by the pseudorandom code and appear in the same range cell. If two vehicles are 40 feet apart in radar radial range and the range cell resolution is 10 feet, both targets are not enhanced by the same code and can be uniquely identified by range. Two targets occupying the same range cell can still be identified by Doppler frequency if they are traveling at different speeds.

Applications

The video display/recording and playback unit 38 (see FIGS. 1 and 2) of the ranging radar system 10 typically comprises a video display screen which is mounted within a patrol vehicle in clear view of a law enforcement officer operating the system. A microprocessor based user interface 39 is operationally connected to the ranging radar system 10. This allows the operator to control features and options of the ranging radar system 10 through keyboard entries, touch screen entries, voice commands, switches, and the like. Alternately, a microprocessor with cooperating data entry devices, such as a keyboard, can be an integral component of the video display/recording and playback unit 38. Control of the radar system 10 and interfacing of the system with other equipment will be discussed in detail in a subsequent section of this disclosure.

Full Range Monitoring

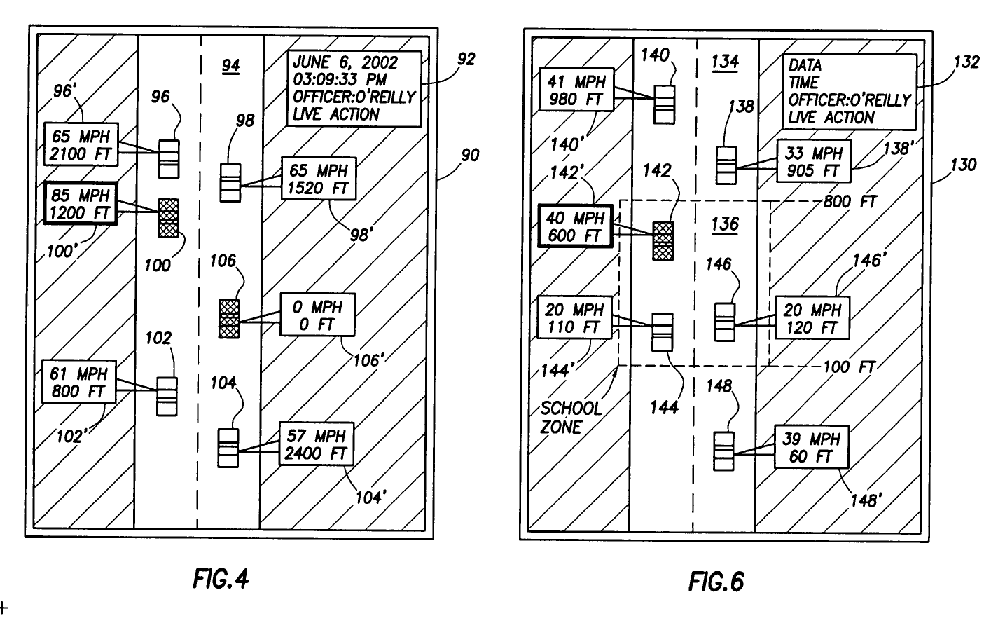

Data provided by the ranging radar system 10 can be used to generate graphical maps of one or more vehicular targets relative to the position of the radar system. An example of such a map 90 is shown in FIG. 4. The map 90 is presented in real-time on the video display of the officer's radar system 10, which is typically mounted within a patrol vehicle. Graphical symbols 96, 100 and 104 represent vehicles moving toward the officer's vehicle 106 on a roadway 94. Symbols 102 and 98 represent vehicles moving away from the officer's vehicle 106. Each vehicle symbol is annotated with vehicle specific signals of (a) vehicular speed and (b) distance relative to the officer's vehicle 106. More specifically, annotations 96′, 98′, 100′, 102′, and 104′ show the speed (in miles per hour) and distance (in feet) of vehicles 96, 98, 100, 102 and 104, respectively, with respect to the officer's vehicle 106. Annotation 106′ indicates that the officer's vehicle is stationary, and positioned at the reference distance of “zero” feet. Speed, distance, and relative direction of movement with respect to the ranging radar system 10 in vehicle 106 are determined using methods discussed previously. Other pertinent data such as date, time of day, and the name of the patrolling officer (e.g. O'Reilly) are preferably displayed in a window 92. The window 92 also preferably indicates if the map is being displayed in real-time mode (“LIVE”), or in playback mode. The officer also can input the posted speed limit into the radar system 10 using the previously discussed data entry devices. Assume, for purposes of discussion, that the posted speed limit is 65 MPH. The system 10 can also be instructed to highlight the image of any vehicle traveling at a speed greater than the posted speed limit. Using the example of a posted 65 MPH limit, the speed of vehicle 100 is measured at 85 MPH as indicated in the annotation 100′. The image of vehicle is shown highlighted by shading in FIG. 4. Other means for highlighting include a change of color, intermittent “blinking” of the image, or any other highlighting means that will draw the attention of the officer. In addition to forming real-time displays, the map 90 can be stored digitally and replayed later using the video display/recording and playback unit 38. This gives the officer the ability to instantly replay an observed event to improve his or her knowledge of the facts used in deciding on a course of action. In summary, the mapping feature of the radar ranging system 10 gives the officer a complete overview of traffic movement within the range of the radar. With both speed and distance being continuously displayed, the likelihood of incorrectly identifying a speeding vehicle in close proximity to a non-speeding vehicle is greatly reduced.

Maps can be generated sequentially thereby providing the officer with an animated view of a traffic flow.

Merging Radar and Supplemental Data

The speed-distance-travel direction data obtained from the ranging radar system 10 can be time-synchronized and merged with a supplemental video system. Radar data can also be merged and time synchronized with an audio communications system, and with navigation systems to locate the position of the patrol vehicle.

The combination of radar data with other supplemental data is shown conceptually as a traffic monitoring system in FIG. 5. Interaction between the ranging radar system 10 and other sources of supplemental data is preferably through a CPU 110. It should be understood that other communication links can be used. As discussed above, the radar system 10 can provide real-time graphical displays 112 and recorded/playback displays 114 of a traffic area using the video display/recording and playback unit 38. Video images of the traffic area can be obtained using a video system. The system can comprise a zoom camera 116 or other suitable video equipment (not shown), such as multiple cameras imaging the traffic area, one or more cameras recording traffic light cycles within the area, and the like. The video system is time-synchronized with radar data through the CPU 110. As mentioned previously, user input means can be an integral element of the radar system 10, or can be a separate element 118 that interfaces with the radar system 10 through the CPU 110. Merged, separate or split screen real-time radar graphical maps and video images or maps of traffic area can be displayed at 122, with time synchronization being controlled by the CPU 10. Likewise, merged or separate radar graphical maps and video images or maps of traffic flow can be recorded and played back under the control of the CPU 10 using commands input into the user interface 118.

The location of the radar system 10 in a moving or stationary vehicle can be tracked, displayed and recorded using a variety of navigation systems including the GPS.

Audio communication can be time-synchronized with radar, video and navigation data using radios and other audio transmitting means in communication with the CPU 110. Such audio communication includes, but is not limited to, communication between officers in the vicinity of a traffic monitoring operation, communication with a monitoring officer and personnel at a remote location such as a base station, communication between an officer in a patrol vehicle containing a radar unit and an officer on foot, and the like.

In summary, the ability to merge traffic radar data with time-synchronized audio, video and navigational data presents a complete record of any and all events occurring within a monitored traffic area. Furthermore, radar, video, audio and navigation information can be recorded by means of a recorder/playback unit 120 that is operationally connected to the CPU 110. The ability to record and to subsequently replay the record of events is very useful for on-site evaluation or as evidence during court appearances.

Range Segment Monitoring

Operational features above essentially include all vehicles within the operating range of the radar system 10. The ranging radar system 10 can also be used to monitor a certain region of roadway using the “range segment” feature discussed in the section BASIC PRINCIPLES. A range segment 76 is shown conceptually in FIG. 3 and expressed in equation (8) as the sum of adjacent range cells. In practical applications, this concept allows the monitoring officer to concentrate on vehicles within a certain region of the road instead of dealing with every target on the road within the range of the radar system 10. Since the radar maximum range can be as great as 3 miles, the ability to monitor a region of roadway defined by a predetermined range segment can improve the monitoring officer's ability to deal with heavy traffic and to insure that a violator is accurately identified, stopped and cited. The region defined by the range segment might be a school zone, a plant entrance, a roadway intersection, or any region of roadway where the speed limit is typically different from the speed limit of adjoining sections of roadway.

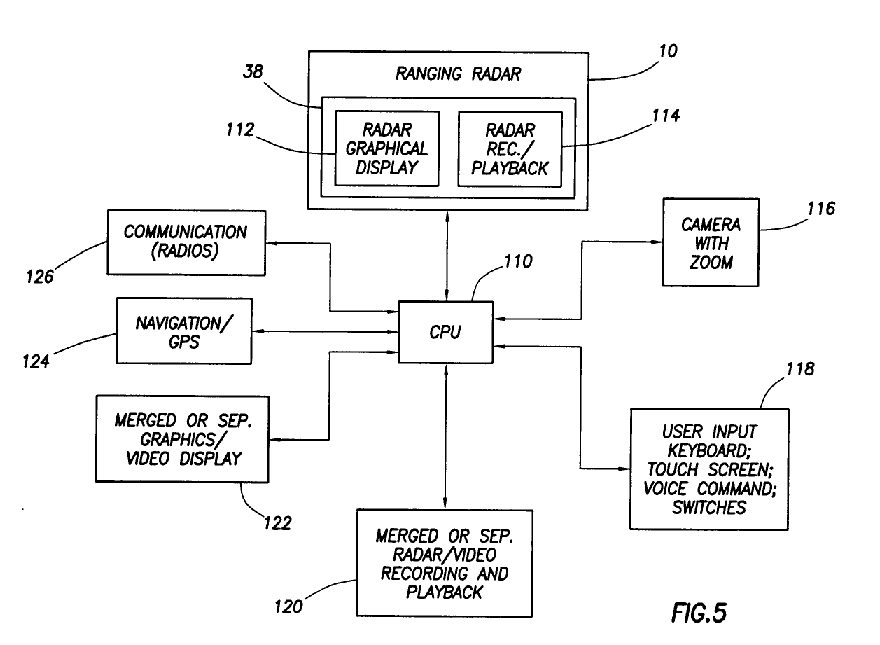

An example of a range segment map is shown in FIG. 6. As with the example shown in FIG. 4, the range segment map 130 is presented in real-time on the video display of the officer's radar system, which is typically mounted within a patrol vehicle. The range segment defines an area of roadway 136 (illustrated by broken lines) which is, for purposes of discussion, a school zone with a speed limit of 20 MPH. Graphical symbols 142, 144 and 146 represent vehicles moving within the school zone 136. Again, each vehicle symbol is annotated with vehicular speed and distance relative to the officer's vehicle (which is not shown on this map). More specifically, annotations 142′, 144′ and 146′ show the speed and distance of vehicles 142, 144 and 146, respectively, with respect to the officer's vehicle. Other pertinent data such as date, time of day, the name of the patrolling officer, and live or playback mode are displayed in a window 132. The officer has input the posted school zone speed limit of 20 MPH. The officer has also defined the range segment of the school zone, which extends from 100 feet to 800 feet relative to the position of the officer's vehicle. Other vehicle images 140, 138 and 148 are shown on the roadway 134 outside of the school zone 136. Annotations 140′, 138′ and 148′ show the speed and range of the vehicles 140, 138 and 148, but are not pertinent to the monitoring of the school zone. These images can either be removed from the display 130, or monitored for speeding vehicles in the regions outside of the school zone, as previously discussed and shown in FIG. 4. The system 10 is again instructed to highlight the image of any vehicle traveling at a speed greater than the posted speed limit of 20 MPH within the school zone. In this example, vehicle 142 is traveling at 40 MPH therefore significantly exceeding the 20 MPH speed limit. The image of vehicle 142 is again shown highlighted by shading, but means for highlighting include color change, “blinking” or any other means that will draw the attention of the officer. The map can be recorded, played back and merged with supplemental data such as video using means and methods discussed previously. In summary, the range segment feature of the radar ranging system 10 gives the officer a complete overview of traffic movement within a specified range segment, while vehicles, traveling outside of the range segment, but within the range of the radar can (1) either be ignored, or (2) monitored for speeding with respect to a different speed limit.

Traffic Statistics

Target range information improves the reliability and accuracy of measured traffic statistics. Prior art traffic statistic radars experienced problems with double counting of vehicles, and can require difficult setup to remove unwanted long-range targets. The ranging radar can be pointed directly into traffic, and long-range returns are easily ignored. With the ability to track a vehicle's position over time, the ranging radar system can better insure that a real vehicle is counted and only counted once. With the use of range segment definitions, traffic statistics can be gathered on a specific section on the road and not side roads, parking lots, and the like.

The range segment feature of the ranging radar system 10 can easily define variably sized intersections, and can be used to control red light cameras or to monitor the density of traffic. This eliminates the need for ground loop detectors, which require destructive road excavation to install or repair.

Other Features

The radar system is designed to spread the operating frequency, or Direct Sequence (DS) spread spectrum. This feature divides transmitted power over a large frequency range thereby minimizing commercially available radar detectors' ability to sense and warn drivers of traffic radar operating in an area.

Rotating objects (such as fans) within a patrol car in which a radar system is operating can cause erroneous radar readings in prior art systems. Range detection and thus range tracking can eliminate false velocity readings from this type of object. A fan within the patrol car will continuously reside in the 0^{th} range cell thus violating range tracking of a true moving object. Using the ranging radar system 10 a detectable object at any detectable range, which provides a higher or lower velocity due to rotation, can be eliminated due to a cross check of Doppler speed and range tracking speed.

Moving mode ranging radar is possible if speeds that occur in multiple range cells are identified. This can be determined to be clutter and the patrol vehicle speed is discovered, the actual target vehicle speeds are calculated, and target speeds similar to the patrol vehicle speed are ignored.

Range tracking history with the disclosed ranging Doppler radar system is a useful method for separating observed “real” targets from observed false or “anomalous” targets. Real targets appear at maximum radar range and progress in a well-behaved, continuous manner through adjacent range cells. Anomalous targets appear and disappear in range cells. Range cell tracking history of a real target on a displayed vehicular map can be compared with vehicular movement that an officer observes through the window of a patrol vehicle. Range cell tracking history improves, therefore, the ability to identify an actual traffic offender.

The radar system as disclosed is directed toward vehicular traffic control applications. It should be understood, however, that the system is also applicable for identifying any target object that reflects an emitted radar signal, and for determining target specific signals comprising range, velocity and direction of motion of the object.

While the foregoing disclosure is directed toward the preferred embodiments of the invention, the scope of the invention is defined by the claims, which follow.

We claim:

1. A ranging Doppler radar system comprising:
(a) a pseudorandom code which modulates a transmitted signal;
(b) a receiver for receiving a return signal containing said pseudorandom code; and
(c) means for decoding said return signal to determine said pseudorandom code; wherein
(d) said pseudorandom code defines a plurality of range cells relative to a location of said ranging Doppler radar system.

2. The system of claim 1 wherein a number of bits in said pseudorandom code defines a location, with respect to said receiver, of each range cell comprising said plurality of range cells.

3. The system of claim 2 wherein a bit rate of said pseudorandom code defines range resolution of said plurality of range cells.

4. The system of claim 2 wherein amplitude of said return signal from a specific range cell is indicative of a target within said specific range cell.

5. The system of claim 4 wherein speed of said target is determined from a Doppler shift in said return signal from said specific range cell.

6. The system of claim 4 wherein speed of said target is determined by measuring time required for said target to move from one range cell to another range cell.

7. The system of claim 4 wherein direction of movement of said target with respect to said system is determined by tracking target movement from one range cell to another range cell.

8. The system of claim 4 wherein:
(a) a range segment is defined by a group of range cells; and
(b) speed of said target within said range segment is determined.

9. The system of claim 4 wherein:
(a) a range segment is defined by a group of range cells; and
(b) direction of movement, with respect to said receiver, of said target within said range segment is determined by tracking movement of said target from one range cell to another range cell within said range segment.

10. The system of claim 4 further comprising means for spreading frequency of said transmitted signal to reduce detection of said transmitted signal by said target.

11. A ranging Doppler radar system comprising:
(a) a source for generating a narrow band of transmit energy;
(b) a direct conversion receiver mixer that receives a first portion of said transmit energy;
(c) a bi-phase modulator which modulates a second portion of said transmit energy with a primitive polynomial pseudorandom code thereby forming a modulated transmit signal transmitted by a transmitter means, wherein said pseudorandom code defines a plurality of range cells;
(d) receiving means for detecting a return signal comprising a portion of said modulated transmit signal reflected from a vehicle residing in at least one of said plurality of range cells; wherein said return signal is
(i) routed through said direct conversion receiver mixer and combined with said first portion to provide two channel I/Q output at base band and comprising at least one vehicle specific signal, and
(ii) said I/Q output is input into a first low pass filter that generates a first filtered signal;
(f) a correlation unit operationally connected to receive said first filtered signal and to output said at least one vehicle specific signal;
(g) a display unit operationally connected to said correlation unit and that receives said at least one vehicle specific signal for display; and
(h) a user interface operationally connected to said system to receive user entered control parameters for said system.

12. The system of claim 11 wherein said correlation unit is an analog correlation apparatus comprising:
(a) a correlation detector that
(i) receives said first filtered signal,
(ii) searches for specific said pseudorandom code related to a specific said range cell to determine if said vehicle is within said specific range cell, and
(iii) generates a correlation output;
(b) a second low pass filter that receives said correlation output and generates a second filtered signal;
(c) an automatic gain control circuit which receives and amplifies said second filtered signal as a function of said specific pseudorandom code thereby yielding an amplified output;
(d) an analog to digital converter that receives said amplified output and digitizes said amplified output yielding digitized amplified output; and
(e) a digital signal processor that receives said digitized amplified output and generates a digitized said at least one vehicle specific signal that is input to said video display/recording and playback unit.

13. The system of claim 11 wherein said correlation unit is a digital correlation apparatus comprising:
(a) a preamplifier that receives and amplifies said first filtered signal thereby generating an amplified output;
(b) an analog to digital converter which receives and digitizes said amplified output generating a digital signal; and
(c) a digital signal processor comprising
(i) a correlation detector that
receives said digital signal,
searches for specific said pseudorandom code related to a specific said range cell to determine if said vehicle is within said specific range cell, and
generates a correlation output, and
(ii) a second low pass filter that receives said correlation output and generates a second filtered signal that comprises at least one said vehicle specific signal that is input to said video display/recording and playback unit.

14. The system of claim 11 wherein said source operates in the Ka frequency range and above.

15. The system of claim 11 wherein:
(a) a number of bits in said pseudorandom code defines a location, with respect to said receiving means, of each of said plurality of range cells; and
(b) a new said pseudorandom code containing said number of bits is generated each time a bit is shifted out by said bi-phase modulator.

16. The system of claim 15 wherein bit rate at which said pseudorandom code is shifted determines:
(a) spreading bandwidth of said narrow band of transmit energy; and
(b) range cell resolution.

17. The system of claim 16 wherein said number of bits is 64.

18. The system of claim 17 wherein a 50 MHz code bit rate yields a range cell with approximate 10 foot range resolution.

19. The system of claim 11 wherein a range segment is defined using input from said user input and comprises a plurality of said range cells.

20. The system of claim 11 wherein one or more vehicle specific signals are determined with respect to a position of said receiving means, wherein said vehicle specific signals comprise vehicle speed, vehicle range, and vehicle direction of travel.

21. The system of claim 11 wherein said at least one vehicle specific signal is measured in at least one said range cell.

22. The system of claim 19 wherein said at least one vehicle specific signal is measured in at least one said range segment.

23. The system of claim 11, wherein the display unit further includes a recording and playback component operationally connected to said correlation unit and that receives said at least one vehicle specific signal for recording and playback.

24. A method for measuring target specific signals using a ranging Doppler radar system, the method comprising:
(a) generating a pseudorandom code that modulates a signal transmitted by said ranging Doppler radar system;
(b) receiving a return signal containing said pseudorandom code; and
(c) decoding said return signal to determine said pseudorandom code; wherein
(d) said pseudorandom code defines a plurality of range cells.

25. The method of claim 24 comprising the additional step of defining a location of each range cell, comprising said plurality of range cells, from a number of bits in said pseudorandom code.

26. The method of claim 25 wherein bit rate of said pseudorandom code defines range resolution of said plurality of range cells.

27. The method of claim 25 comprising the additional step of locating a target within said specific range cell by measuring amplitude of said return signal from a said specific range cell.

28. The method of claim 27 comprising the additional step of determining speed of said target from a Doppler shift in said return signal from said specific range cell.

29. The method of claim 27 comprising the additional step of determining speed of said target by measuring time required for said target to move from one range cell to another range cell.

30. The method of claim 27 comprising the additional steps of:
(a) determining speed of said target from a Doppler shift in said return signal from said specific range cell thereby obtaining a first speed-measurement;
(b) determining speed of said target by measuring time required for said target to move from one range cell to another range cell thereby obtaining a second speed measurement; and
(c) comparing said first speed measurement and said second speed measurement to obtain a true vehicle speed and eliminate false velocity readings.

31. The method of claim 27 comprising the additional step of determining direction of movement of said target with respect to said system by tracking target movement from one range cell to another range cell.

32. The method of claim 27 comprising the additional step of defining a range segment comprising a plurality of range cells.

33. The method of claim 32 comprising the additional step of determining speed of said target within said range segment from a Doppler shift in said return signal from said plurality of range cells within said range segment.

34. The method of claim 32 comprising the additional step of determining speed of said target within said range segment by measuring time of target movement from one range cell to another range cell within said range segment.

35. The method of claim 32 comprising the additional step of determining direction of movement of said target, with respect to said system, by tracking target movement from one range cell to another range cell within said range segment range segment.

36. The method of claim 25 further comprising the step of spreading frequency of said transmitted signal to reduce detection of said transmitted signal by said target.

37. The method of claim 27 comprising the additional step of determining speed of a first target and a second target moving at different speeds within a same range cell by comparing Doppler frequencies measured from said same range cell.

38. The method of claim 31 comprising the additional step of separating a real target from an anomalous target by observing a tracking history of said target movement, wherein said real target is identified by said tracking history showing well-behaved movement through said range cells.

39. A method for monitoring vehicular traffic using a ranging Doppler radar system, the method comprising:
(a) generating a narrow band of transmit energy with a source;
(b) diverting a first portion of said transmit energy to a direct conversion receiver mixer;
(c) modulating a second portion of said transmit energy with a primitive polynomial pseudorandom code using a bi-phase modulator thereby forming a modulated transmit signal transmitted by a transmitter means, wherein said pseudorandom code defines a plurality of range cells;
(d) detecting, with receiving means, a return signal comprising a portion of said modulated transmit signal reflected from a vehicle residing in one of said plurality of range cells disposed with respect to said receiving means; wherein said return signal is
(i) routed through said direct conversion receiver mixer and combined with said first portion to provides two channel I/Q output at base band and comprising at least one vehicle specific signal, and
(ii) said I/Q output is input into a first low pass filter that generates a first filtered signal;
(f) inputting said first filtered signal into a correlation unit and outputting from said correlation unit at least one vehicle specific signal;
(g) inputting said at least one vehicle specific signal into a video display/recording and playback unit for display and recording; and
(h) entering control parameters for said system into a user interface operationally connected to said system.

40. The method of claim 39 wherein said correlation unit is an analog correlation apparatus comprising:
(a) a correlation detector that
(i) receives said first filtered signal,
(ii) searches for specific said pseudorandom code related to a specific said range cell to determine if said vehicle is within said specific range cell, and
(iii) generates a correlation output;
(b) a second low pass filter that receives said and generates a second filtered signal;
(c) an automatic gain control circuit that receives and amplifies said second filtered signal as a function of said specific pseudorandom code thereby yielding an amplified output;
(d) an analog to digital converter that receives said amplified output and digitizes said amplified output yielding digitized amplified output; and
(e) a digital signal processor that receives said digitized amplified output and generates said at least one vehicle specific signal that is input to said video display/recording and playback unit.

41. The method of claim 39 wherein said correlation unit is a digital correlation apparatus comprising:
(a) a preamplifier that receives and amplifies said first filtered signal thereby generating an amplified output;
(b) an analog to digital converter which receives and digitizes said amplified output generating a digital signal; and
(c) a digital signal processor comprising
(i) a correlation detector that
receives said digital signal,
searches for specific said pseudorandom code related to a specific said range cell to determine if said vehicle is within said specific range cell, and
generates a correlation output, and
(ii) a second low pass filter that receives said correlation output and generates a second filtered signal that comprises at least one said vehicle specific signal that is input to said video display/recording and playback unit.

42. The method of claim 39 comprising the additional step of operating said source in the Ka-band frequency range and above.

43. The method of claim 39 comprising the additional steps of:
(a) using a number of bits in said pseudorandom code to define a location with respect to said receiver means of each of said plurality of range cells; and
(b) generating a new said pseudorandom code containing said number of bits each time a bit is shifted out by said bi-phase modulator.

44. The method of claim 43 wherein bit rate at which said pseudorandom code is shifted determines:
(a) spreading bandwidth of said narrow band of transmit energy; and
(b) range cell resolution.

45. The method of claim 44 wherein said number of bits is 64.

46. The method of claim 44 wherein a 50 MHz code bit rate yields a range cell with approximate 10 foot range resolution.

47. The method of claim 39 comprising the additional step of defining a range segment using input from said user input, wherein said range segment comprises a plurality of said range cells.

48. The method of claim 39 comprising the additional step of determining at least one of said vehicle specific signals with respect to a position of said receiving means, wherein said vehicle specific signals comprise vehicle speed, vehicle range, and vehicle direction of travel.

49. The method of claim 39 comprising the additional step of measuring said at least one vehicle specific signal in at least one said range cell.

50. The method of claim 47 comprising the additional step of measuring said at least one vehicle specific signal in at least one said range segment.

51. The method of claim 39 comprising the additional step of dwelling on said specific range cell in which said vehicle is found to optimize signal to noise ratio.

52. The method of claim 39 wherein direction of travel of said vehicle with respect to said Doppler radar system is determined using said I/Q output.
